(19) United States
(12) Patent Application Publication
(10) Pub. No.: US 2011/0000685 A1
(43) Pub. Date: Jan. 6, 2011

(54) DRY-TYPE VACUUM SPRINKLER SYSTEM

(76) Inventor: Gengo Matsuoka, Chiba (JP)

Correspondence Address: Muncy, Geissler, Olds & Lowe, PLLC, 4000 Legato Road, Suite 310, FAIRFAX, VA, 22033, US

(21) Appl. No.: 12/865,835

(22) PCT Filed: Feb. 1, 2008
(86) PCT No.: PCT/JP2008/051625

§ 371 Date: Aug. 2, 2010

(51) Int. Cl. A62C 35/62

(52) U.S. Cl. 169/17

(57) ABSTRACT

A dry-type vacuum sprinkler system is provided, from which water remaining in a secondary pipe system can be easily removed and shortcomings typically seen in a dry-type sprinkler system are dissolved. The dry-type vacuum sprinkler system of the invention is secured from a quick fire extinguishment operation at the time of a fire. The sprinkler system of the invention includes a negative pressure state maintenance member for maintaining air charged in the secondary pipe system in a negative pressure state. The negative pressure state is defined as a normal state in the invention. The negative pressure state maintenance member includes a suction pipe 53 which extends to an upper position of the secondary pipe system 24, and communicates with the secondary pipe system 24, and a suction pump 51 provided on the suction pipe 53. The suction pump 51 suctions the air of the secondary pipe system 24 from the upper position of the secondary pipe system 24. At a part above the secondary pipe system, a temperature detection member 57a for detecting a temperature in the secondary pipe system and a pressure detection member 57b for detecting a pressure in the secondary pipe system are provided. The pressure in the secondary pipe system 24 is controlled so that water 62 remained in the secondary pipe system 24 boils at the temperature detected by the temperature detection member 57a, in the normal state.

### FIELD OF THE INVENTION

The present invention relates to a dry-type vacuum sprinkler system, e.g., for a cold climate. More specifically, the present invention relates to a dry-type vacuum sprinkler system wherein water remaining in hang-down pipes of a secondary pipe system can be eliminated without operating or detaching the sprinkler heads, in addition to prompt and secured fire extinguishment operation upon occurrence of a fire.

### BACKGROUND ART

Sprinkler systems are largely classified into dry-type and wet-type systems. The classification is made based on the state of the secondary pipe system, i.e., whether or not the secondary pipe system is charged with water as a usual/normal condition. A dry-type sprinkler system is often used in cold districts, where water may freeze.

FIG. 4 is a schematic diagram for showing the entire structure of a dry-type sprinkler system 100. The dry-type sprinkler system 100 comprises basic structural components, i.e., a fire extinguishment water tank 16, a water feed pump 14, a water feed pipe arrangement 20, and sprinkler heads 12.

The fire extinguishment water tank 16 is located in a basement of a building. The tank 16 stores water in a volume sufficient to discharge water for a long time from the sprinkler heads 12 provided on each floor of the building. The water feed pump 14 functions as a water supply unit and has a capacity for discharging water at a rate of 80 liters or more per minute from each of 8 to 40 sprinkler heads simultaneously, even considering water-flow resistance in the pipe system.

The feed pipe arrangement 20 includes a primary pipe system 22, gate valves 26, and secondary pipe system 24, forming a water supply line from the water feed pump 14 to the sprinkler heads 12. The primary pipe system 22 extends in an approximately vertical direction from the water feed pump 14 to an uppermost floor of the building, e.g., a department store, and branches to configure the secondary pipe system on each floor. Moreover, an overhead water tank 62 is provided on the uppermost part of the building. The tank 62 also stores water. As discussed below, the secondary pipe system 24 is arranged approximately parallel to the ceiling of each floor. A plurality of sprinkler heads 12 is provided on each pipe system 24.

The inner diameters of the primary pipe system 22 and the secondary pipe system 24, the number of sprinkler head 12 on each floor, and the output of the water feed pump 14 can be appropriately selected in accordance with the size of the building or the area of each floor taken into account.

FIG. 5 is a schematic diagram for showing the main structure of the dry-type sprinkler system shown in FIG. 4. The water in the fire extinguishment water tank 16 is discharged passing through the water feed pump 14, the primary pipe system 22, the gate valves 26, the secondary pipe system 24, and the sprinkler heads 12. As shown in the figure, the primary pipe system 22 is branched to configure a branched pipe system for each floor. Each gate valve 26 is connected to an upper end of the branch pipe system for water supply. The gate valve 26 includes an electrically operated valve 26a and an alarm valve 26b. The electrically operated valve 26a is maintained to be closed in a normal condition. The alarm valve 26b functions as an alarm, when the electrically operated valve 26a opens and water discharge is carried out for a predetermined time.

The secondary pipe system 24 on each floor extends approximately parallel to the ceiling of the floor, with one end of the secondary pipe system 24 in communication with the gate valve 26. Each pipe system 24 is branched and the branched parts extend in a downward vertical direction. Namely, hang-down pipe portions 24b are provided on the secondary pipe system 24. Sprinkler heads 12 are installed to a free end of the hang-down pipe portions 24b so as to be exposed from the ceiling on each floor. It is not necessary that the secondary pipe system 24 has a diameter as large as that of the primary pipe system 22. The diameter, material and thickness of the secondary pipe system 24 can be freely selected so that the pipe system 24 is tolerable under a predetermined pressure condition. Further, a test valve 28 is provided on another end of the secondary pipe system 24, for evacuating the secondary pipe system 24 after water is supplied to the pipe system 24 for an experiment or system malfunction.

The sprinkler head 12 has a large number of discharge holes (not shown) in an end surface thereof. The discharge holes are closed in a normal condition. Each sprinkler head 12 individually has a function for opening the discharge holes for blowing out water therefrom, when the ambient temperature is increased to a predetermined high temperature, e.g. to 80 □. For opening the discharge holes, a metal having a low melting point is generally used, for utilizing the high-temperature melting property of the metal. Alternatively, it is possible to use any other structure or configuration as long as the above-discussed function is attained.

In addition to the above described structure, the dry-type sprinkler system 100 is provided with a fire detector 40 and a control panel 30, for performing a pre-action function. The fire detector 40, that is, a member for detecting a fire is provided on each floor. The fire detector 40 is highly sensitive and quickly detects smoke, flame, and ambient temperature. When the ambient temperature is increased to a predetermined high level, the detector 40 transmits a fire signal FS to the control panel 30. The fire detector 40 needs to detect the ambient temperature etc. more quickly than the sprinkler heads 12.

The control panel 30 functions as a control section for opening and closing the system. The control panel 30 includes the following units:

an input block (not shown) which receives various signals from the outside,

a determination block (not shown) composed of a memory, a relay circuit, etc. which is operated according to a preset control theory, and

an output block (not shown) which generates control signals (CS2, CS3) to each of the valves 26 and the water feed pump 14 for supplying electricity to the same. With this structure, the control panel 30 can control the opening degree, open/closed states, etc. of each valve after making determination based on the fire signal FS transmitted from the fire detector 40.

In this state, the secondary pipe system 24 is filled with air which is pressurized to about 2 kgf/cm² by a pressure application member. The pressure application member includes a compressor 50, a pressure application pipe 52 and a pressure application electromagnetic valve 54. More specifically, the pressure application pipe 52 has an end communicating with a branch pipe 24a. The branch pipe 24 extends upwardly from the uppermost part of the secondary pipe system 24. Then, the pressure application pipe 52 extends approximately in a horizontal direction, and further extends downwardly for a predetermined length. The horizontal part of the pressure application pipe 52 is provided with a pressure application electromagnetic valve 54. A lower end of the pressure application pipe 52 is connected to the compressor 50. When the inside of the secondary pipe system 24 does not have a predetermined pressure, a pressure switch 56 detects the insufficient pressure, transmits a pressure signal PS to the control panel 30. The control panel 30 transits control signals CS1 and CS4 to the pressure application electromagnetic valve 54 and the compressor 50, respectively. In response, the pressure application valve is opened, the compressor 50 starts the operation, and pressure is applied to the inside of the secondary pipe system 24 by the compressor 50.

At this stage, the secondary pipe system 24 is filled with a pressurized air. There is such an advantage in the dry-type sprinkler in this state that only air blows out. In other words, it is possible to prevent water damage as in wet-type sprinklers. On the other hand, Patent Literature 1 discloses a wet-type sprinkler which does not cause water damage.

In the dry-type sprinkler system, however, it is necessary to remove water from the secondary pipe system 24 after an experimental water discharge or system malfunction. Even after water is removed from the dry-type sprinkler system, water in no small quantities remains in the hang-down pipes 24b, unless the sprinkler heads 12 are individually operated or detached from the hang-down pipes. Remaining water 62 is shown in FIG. 5. As a result, rust-corrosion readily occurs at an area exposed to the air where water contacts the air in the hang-down pipes 24b. The corrosion would progress easily, to make a hole in a wall of the pipe/pipe system. Therefore, it is indispensable to carry out periodical maintenance or repair, or to use a pipe system made of a special material. Thus, economical burden of the administrator was not small.

In view of the conventional dry-type sprinkler system, a fire extinguishment installation has been proposed, wherein a part of the secondary pipe system immediately above the sprinkler heads is charged with an inert gas instead of air. It is possible to prevent the generation or extension of rust by using the inert gas such as nitrogen gas.

Patent Literature 1: Japanese Patent No. 3264939

Patent Literature 2: Japanese Laid-Open Patent Application 10-234881.

### DISCLOSURE OF THE INVENTION

Problems to be Solved by the Invention

In the dry-type sprinkler system, as discussed relating to the background art, water remains in the hang-down pipe in the secondary pipe system. No proposal has been made as to a method for easily eliminating the remaining water.

The water removal from the secondary pipe system, as discussed concerning the background art, is completed in a few minutes. On the other hand, when water remaining in the hang-down pipe is also to be removed, it is necessary that the sprinkler heads 12 are individually operated or detached from the hang-down pipes. In other words, a large amount of time and labor are required for the water removal from the hang-down pipes.

In the secondary pipe system charged with air, a small amount of air is more likely leaked from the pipe system, e.g., at joint parts of the pipes, compared to the secondary pipe system charged with water. Therefore, the pressure decrease is relatively fast when the secondary pipe system is charged with air. Then, it is necessary to supply air into the secondary pipe system 24 frequently by use of the compressor 50. However, the air supplement would promote rust generation, since oxygen is further supplied.

When water is discharged for actual fire extinguishment, water pressurized to about 7 to 10 kgf/cm² outflows from the water feed pump into the secondary pipe system 24 simultaneously with opening the gate valve 26. In this case, if air remains at a corner or an upper part of the pipe system, it is possible that the effective cross-sectional area for the water discharge is decreased and that the water flow is hindered.

When the above-discussed high pressure water is introduced to non-operated sprinkler heads, the air stored in the pipe system is compressed to generate a high-pressure air. It is apprehended that the high-pressure air blows off parts in the sprinkler system such as sprinkler heads by the elastic force of the air. Further, water is not discharged until the air is removed from the pipe system, upon occurrence of a fire. Therefore, the extinction action at the initial stage (i.e., a primary object) in the dry-type sprinkler system is evaluated to be poor, compared to the wet-type sprinkler system.

The fire extinguishment system disclosed in Patent Literature 2 is charged with an inert gas. When this fire extinguishment system is used, especially when the sprinkler heads operate in a relatively small and air-tight room, a room can be filled with the inert gas such as nitrogen gas. Thus, oxygen defect condition can be arisen, and the safety could be lost. Therefore, the use of the fire extinguishment system is not proper in the above-mentioned room.

It is therefore an object of the present invention to provide a dry-type vacuum sprinkler system wherein water remaining in the secondary pipe system is easily removed, and a first fire extinguish operation is secured, without having any conventional shortcomings.

### MEANS TO BE SOLVED BY THE INVENTION

The above object of the present invention is solved by a dry-type vacuum sprinkler system comprising sprinkler heads which function individually, a water supply unit provided for supplying water to the sprinkler heads, a water feed pipe system unit configured as a water supply path for supplying water from the water supply unit to the sprinkler heads, the water supply unit comprising a primary pipe system connected to the water supply unit, a secondary pipe system connected to the sprinkler heads, and a gate valve provided between the primary pipe system and the secondary pipe system and partitioning the water feed pipe system into the primary pipe system and the secondary pipe system, the gate valve being closed in a normal condition, the normal condition being a state where the primary pipe system is filled with water and the secondary pipe system is not filled with water, a fire detection member which transmits a fire signal upon detection of a fire, a control unit for controlling an operation of the water supply unit and an open-close action of the gate valve, and a negative pressure state maintenance member configured to suction air in the secondary pipe system and maintain the inside of the secondary pipe system in a negative pressure state.

By use of the above structure, it is possible that the air in charged in the secondary pipe system of the water feed pipe system is changed into a negative pressure state, when necessary, by the negative pressure state maintenance member. Therefore, water remaining in the hang-down pipe of the secondary pipe system can be boiled and vaporized therein by setting the pressure in the secondary pipe system negative. Thus, the water can be easily removed without performing any special operation such as detachment of the sprinkler heads.

Under occurrence of a fire, an open-close control unit receives a fire signal from a fire detector, and opens the gate valve, and starts the operation of the water supply unit. Therefore, water is transmitted from the first pipe system to the second pipe system, and an atmospheric pressure state or negative pressure state in the secondary pipe system is changed into a pressurized state. Under this pre-action state, the sprinkler heads individually open to perform water injection. Namely, the secondary pipe system is charged with water under atmospheric pressure state or a negative pressure state, and then brought into a pressurized state. Therefore, the water does not remain at the corners or an upper part of the pipe system. Moreover, it is not possible that the air in the secondary pipe system is compressed to give a highly pressurized air. Accordingly, problems specific to conventional dry-type sprinkler systems are solved. In the present invention, there is no need to concern the effective cross-sectional area to be decreased, parts for the sprinkler heads to be blown off, the immediacy initial fire extinguish operation to be loosen. A quick fire extinguish operation at occurrence of a fire is ensured in the present invention.

In the dry-type vacuum sprinkler system of the invention, the negative pressure state maintenance member can comprise a pressure control unit which maintains the inside of the secondary pipe system in a negative pressure state as the normal condition.

Accordingly, the inside of the secondary pipe system has a negative pressure in the normal condition. Therefore, it is possible to maintain the water remaining in the secondary pipe system being boiled for a long time. Water can be smoothly transmitted from the primary pipe system to the secondary pipe system at occurrence of a fire since the pressure in the secondary pipe is maintained negative. In other words, a fast fire extinguish operation is secured.

In the dry-type vacuum sprinkler system of the invention, it is possible that the negative pressure state maintenance member comprises a pressure detection member which detects the pressure in the secondary pipe system, the pressure control unit controlling the pressure in the secondary pipe system to a predetermined value, when the pressure in the secondary pipe system becomes greater than the predetermined value.

By use of the above-discussed structure, it is possible that the pressure control unit brings a pressure in the secondary pipe system back to the predetermined value, when the pressure is increased beyond the predetermined value. For example, it is possible to control a pressure in the hang-down pipe to have a predetermined value so as to boil and vaporize the water remaining in the secondary pipe system. Namely, it is possible to easily remove the water remaining, without carrying out any special operation such as detachment of sprinkler heads.

In the dry -type vacuum sprinkler system of the invention, it is possible that the negative pressure state maintenance member further comprises a temperature detection member which detects a temperature in the secondary pipe system, and a pressure detection member which detects a pressure in the secondary pipe system, the pressure control unit controlling the pressure in the secondary pipe system in the normal condition so that water remaining in the secondary pipe system boils at a temperature detected by the temperature detection member.

By use of the above-discussed structure, the pressure control unit receives information from the temperature detection member, as to the temperature in the secondary pipe system. The pressure control unit comprises a structure for controlling the pressure in the secondary pipe system so that water remaining in the secondary pipe system boils at the temperature. Further, the pressure in the secondary pipe system is determined by the pressure detection member, and the pressure control is carried out by the negative pressure maintenance member. Accordingly, the water remaining in the secondary pipe system certainly boils, by the negative pressure state in the secondary pipe system being maintained systematically in a stable condition.

In the dry-type vacuum sprinkler system of the invention, it is possible that the negative pressure state maintenance member further comprises a suction pipe extending to a position above the secondary pipe system and communicating with the secondary pipe system, and a suction member for suctioning air in the secondary pipe system by way of suction pipe to have a negative pressure in the secondary pipe system.

By use of the above-discussed structure, the pressure in the secondary pipe system is made negative. The negative pressure state is prepared by the suction pipe communicating with an upper position of the secondary pipe system in the water feed pipe system, and the suction member for suctioning air in the secondary pipe system by way of the suction pipe. The negative pressure maintenance member with a simple structure performs a secured function.

### EFFECT OF THE INVENTION

In the dry-type vacuum sprinkler system of the invention, the inside of the secondary pipe system is maintained in a negative pressure condition. Therefore, water remaining in the hang-down pipe portions 24b can be boiled. In other words, no special operation such as detachment of sprinkler heads is required and water remaining in the pipes can be easily eliminated by boiling the same. Moreover, in the event of actual fire, water is transmitted from the primary pipe system to the secondary pipe system. Then, the atmospheric condition or the negative pressure condition in the secondary pipe system is changed to a pressurized condition. Therefore, a prompt fire extinguishment action is certainly provided by using the sprinkler of the invention.

Eventually, a dry-type vacuum sprinkler system is provided, which can be used for a long time without any concern.

### BEST MODE FOR CARRYING OUT THE INVENTION

The embodiment of the present invention will now be described by referring to the figures. FIG. 1 is a schematic diagram for showing a structure (main parts) of a dry-type vacuum sprinkler system of the present invention. In the same way as in the conventional dry-type sprinkler system, water stored in a water tank 16 is discharged from sprinkler heads 12 through a water feed pump 14, a primary pipe system 22, a gate valve 26, and a secondary pipe system 24. The members in FIG. 1, which are the same as those in FIG. 5, are expressed by the same reference numerals as in FIG. 5. The dry-type sprinkler system will be described in detail, as to the points which are different from the conventional dry-type sprinkler system.

As shown in FIG. 1, the inside of the secondary pipe system 24 is maintained at a negative pressure by means of a negative pressure state maintenance member. In the present invention, the negative pressure state is defined as a normal condition. The negative pressure state maintenance member includes a suction pipe 53, a suction member and a suction electromagnetic valve 55. The suction pipe 53 is communicated with an upper part of the secondary pipe system 24. The suction member is provided on the suction pipe 53, and the inside of the secondary pipe system 24 is suctioned by the suction pump 51, from the upper part of the secondary pipe system 24. In the present embodiment, a suction pump 51 is used as the suction member. Therefore, the air charged in the secondary pipe system 24 is suctioned by the suction operation of the suction pump 51. Thus, the pressure in the secondary pipe system 24 is made negative.

Describing the above structure more concretely, a connection pipe 24a is provided on the secondary pipe system 24 and is in communication therewith. The suction pump 51 is connected to a lower end of the suction pipe 53. Further, the suction electromagnetic valve 55 is provided on the suction pipe 53, at the side of the connection pipe 24a.

A temperature detection member 57a and a pressure detection member 57b are provided on the connection pipe 24a provided on the secondary pipe system 24. In the present embodiment, a generally used thermister and a generally used press meter can be used as the temperature detection member 57a and the pressure detection member 57b, respectively. In the present embodiment, the temperature detection member 57a and the pressure detection member 57b have individual structures. Alternatively, the members 57a and 57b can be configured as an integrated structure. The temperature and the pressure in the secondary pipe system detected by the detection members are transmitted as a detection signal PS to the control panel 30.

As shown in FIG. 5, the control panel 30 includes an open-close control unit which controls the open-close action of the gate valve 26 and the operation of the water feed pump 14. The control panel 30 further comprises a pressure control unit for controlling the pressure in the secondary pipe system 24. The suction electromagnetic valve 55 is configured to open and close in response to a control signal CS1 from the control panel 30. Moreover, the control panel 30 transmits a control signal CS4 to the suction pump 51 for controlling the operation and suspension of the suction pump 51.

It is necessary for the dry-type sprinkler system of the present invention to eliminate water from the secondary pipe system 24, if the sprinkler system erroneously functions or water is discharged for an experiment. Even after the water elimination, water in no small amount remains in the hang-down pipes 24b. The remaining water is denoted by reference numeral 62 in FIG. 1.

A method for eliminating the remaining water 62 in the hang-down pipes 24b will be discussed below. After the water elimination operation after a system malfunction or experimental water discharge, the electromagnetic valve 26a and alarm valve 26b provided at the side of water feed pump 14 (i.e., the gate valve 26), and a test valve 28 provided on the other end, which is opposed to the gate valve 26, of the secondary pipe system 24, and the suction electromagnetic valve 55 provided on the suction pipe 53 are maintained to be closed. In other words, the secondary pipe system 24 is under a sealed condition.

The control panel 30 firstly receives information as to the temperature in the secondary pipe system 24, from the temperature detection member 57a. Then, a pressure is determined, that is for boiling water in the secondary pipe system 24 at the informed temperature. In other words, a pressure for vaporizing the liquid water is obtained. The pressure is obtained from the phase diagram of water.

FIG. 2 is the phase diagram of water. At atmospheric pressure, i.e., 101325 Pa, water freezes at 0° C. and boils at 100° C. Namely, water is changed into a solid at 0° C., and gas, at 100° C. However, water boils at a temperature lower than 100° C. when the pressure is decreased. For this purpose, a pressure for boiling the remaining water 62 at the temperature in the secondary pipe system 24 can be obtained from the phase diagram of water. For example, when the temperature in the secondary pipe system 24 is determined as T1, the pressure in the secondary pipe system 24 should be P1, for boiling the water in the pipe system 24 at temperature T1. More specifically, when the temperature in the secondary pipe system is 20° C., the remaining water 62 boils at that temperature, when the pressure in the secondary pipe system is set to be about 2000 Pa.

In the present invention, the control panel 30 controls a negative pressure state maintenance member, for setting the pressure in the secondary pipe system 24 to the predetermined value. Herein, the negative pressure state maintenance member comprises the suction pipe 53, the suction pump 51 and the suction electromagnetic valve 55 provided on the suction pipe 53. The suction pipe 53 extends to an upper portion of the secondary pipe system 24, and is in communication therewith. The suction pump 51 is provided on the suction pipe 53 as the suction member, and the inside of the secondary pipe system 24 is suctioned by the suction pump 51, from the upper position of the secondary pipe system 24. More concretely, the control panel 30 transmits a control signal CS1 with respect to the electromagnetic valve 55, to open the suction electromagnetic valve 55. Subsequently, the control panel 30 outputs a control signal CS4 with respect to the suction pump 51 for suction operation. Thus, the pressure in the secondary pipe system 24 is made negative. When the predetermined pressure is obtained as a result of sequential detection of the pressure by use of the suction pump 57b, a control signal CS1 is transmitted to the suction electromagnetic valve 55 to close the valve 55. At the same time, the control signal CS4 is transmitted to the suction pump 51 to suspend the suction pump 51. As a result, the pressure in the secondary pipe system 24 is maintained so that the remaining water 62 boils and vaporizes.

FIG. 3 is a flowchart for explaining a function of the control panel 30.

First, the control panel 30 determines temperature T1 in the secondary pipe system 24 by the temperature detection member 57a (step 1). Subsequently, pressure P1 is obtained, which is for boiling water at temperature T1 (step 2). It is possible to perform step 2, for example, by preparing and storing a database based on the phase diagram of water, in advance, in the control panel 30. By use of the data base, it is possible to promptly obtain a pressure corresponding to an input temperature. Then, pressure P prevailing in the secondary pipe system 24 is determined by the pressure detection member 57b (step 3).

Thereafter, the thus obtained pressures P and P1 are compared with each other (step 4). When the relationship P≦P1 is not satisfied, the suction electromagnetic valve 55 is opened, and the suction pump 51 is operated (step 5). When the relationship P≦P1 is satisfied, the suction electromagnetic valve 55 is closed, and the suction pump 51 is suspended (step 6). Thus, the pressure in the secondary pipe system 24 is maintained negative.

By maintaining the pressure in the secondary pipe system 24 negative as mentioned above, the remaining water 62 boils and vaporizes. Namely, the remaining water can be easily eliminated. Moreover, it is possible to perform the control flow in FIG. 3 at a predetermined interval, e.g., of 10 minutes intermittently. In this case, it is possible to effectively eliminate the remaining water 62 by controlling the pressure so as to boil the water 62, even when the temperature in the secondary pipe system 24 is changed by the effect of ambient temperature.

In the dry-type vacuum sprinkler system of the present invention, the remaining water can be effectively removed. Therefore, the problem, i.e., the corrosion of the hang-down pipe 24b has been completely solved. Consequently, periodical maintenance or repair, or the use of special materials for the pipe system is not required. Thus, the economical burden for the administrator of the sprinkler system can be minimized as far as possible.

In the fire monitoring state, fire detectors 40 monitor whether or not a fire occurs, at predetermined locations on the floors. In case of a fire occurring at one of the locations, the fire detector 40 detects existence of a fire state, and transmits a fire signal FS to the control panel 30.

The control panel 30, which has received the fire signal FS by way of the input block, transmits a control signal CS2 from an output block in the control panel 30. The control signal CS2 gives an instruction to drive the electronically operated valve 26a provided on the floor where the fire detector 40 detected the fire. Thus, the electronically operated valve 26a opens. Further, the control panel 30 outputs a control signal CS1 to the suction electromagnetic valve 55 for suction, simultaneously with the output of the signal CS2. The control panel 30 also transmits a control signal CS4 to the suction pump 51. Upon the receipt of the signal, the suction electromagnetic valve 55 is closed, and the suction pump 51 is stopped. Simultaneously, the control panel 30 supplies a control signal CS3 to the water feed pump 14 for activating the same. In response, the water feed pump 14 starts to drive.

Then, a pre-action is carried out. In other words, a large volume of pressurized water stored in the primary pipe system 22 flows into the secondary pipe system 24 on the floor where the fire has broken out. Therefore, the water in the negative pressure state in the secondary pipe system 24 is changed into a highly pressurized state at the level, e.g., of 6 kgf/cm².

Upon the initial occurrence of fire, at least one of the sprinkler heads 12 is exposed to heat and actuated. Then, the highly pressurized water in the secondary pipe system 24 is instantly expelled from the sprinkler head 12 to start a fire extinguish operation. By the expulsion of water from the sprinkler head 12, the sprinkler system is in a water-supply state in which water is continuously supplied from the primary pipe system(s) 20 to the secondary pipe system(s) 24. Under this situation, the alarm valve 26b starts to function, and an alarm for notifying the activation of the sprinkler system goes off. The above sequential operations cause the sprinkler heads 12 to continuously discharge water.

The continuous water discharge eliminates a possibility of injecting compressed air from the sprinkler head 12. Therefore, drawbacks such as scattering parts of the sprinkler head 12 do not happen, that had been seen at high-pressure air injection in the conventional sprinkler system.

In addition to the above, the secondary pipe system 24 under the negative pressure state is charged with water in the present invention. Therefore, the air does not remain even at corners or upper parts of the pipe system. Water pressurized to about 7 to 10 kgf/cm² is flown into the secondary pipe system 24 simultaneously with opening the gate valve 26.

In this case, there is no need to concern the decrease of the effective cross-sectional area for the water flow or the hindrance of the water flow.

Moreover, in the dry-type vacuum sprinkler system of the present invention, the open-close control unit in the control panel 30 is configured to open the gate valve 26 only when the open-close control unit receives a plurality of fire signals FS within a predetermined time. Accordingly, it is possible to effectively prevent the negative pressure state in the secondary pipe system from being broken, or being changed into a pressurized state by a mere malfunction of the fire detector 40.

As explained above, in the dry-type vacuum sprinkler system of the present invention, it is possible to easily eliminate water remaining in the secondary pipe system. Namely, the dry-type vacuum sprinkler system of the invention can maintain a prompt fire extinguish operation under occurrence of a fire, with eliminating a problem peculiar to the dry-type sprinkler system.

The present invention can be variously modified without departure from the scope of the invention, and is not limited to the above-discussed embodiments. For example, the secondary pipe system is filled with water molecules after boiling water remaining in the secondary pipe system. It is possible to adopt a structure for periodically eliminating the vaporized water molecules by use of a suction pump 51.

### BRIEF DESCRIPTION OF THE DRAWINGS

FIG. 1 is a schematic diagram for explaining an essential structure of a dry-type vacuum sprinkler system of the present invention.

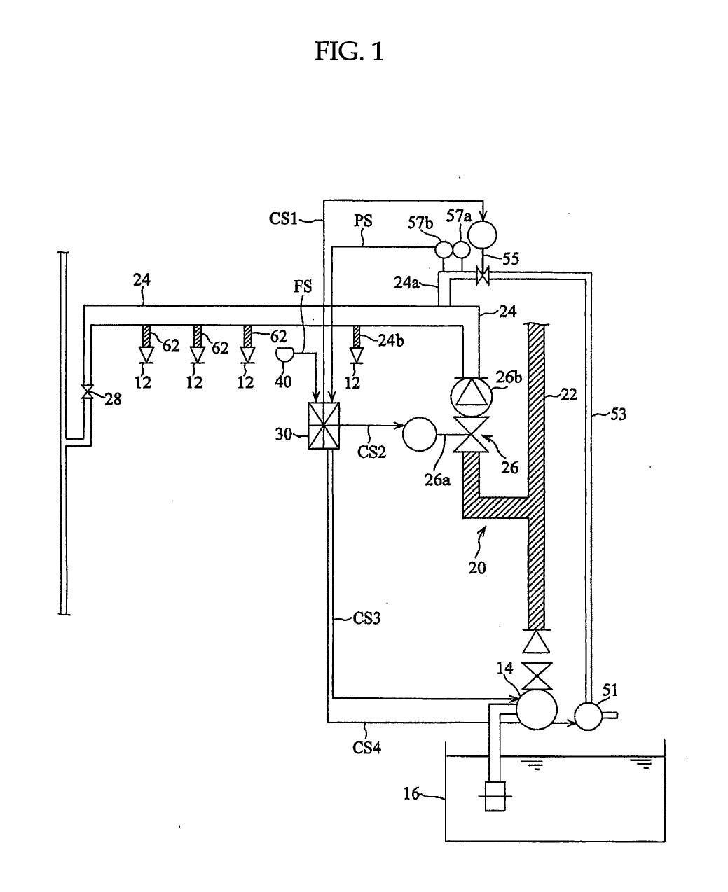

FIG. 2 is a phase diagram of water to be used for a dry-type vacuum sprinkler system of the present invention.

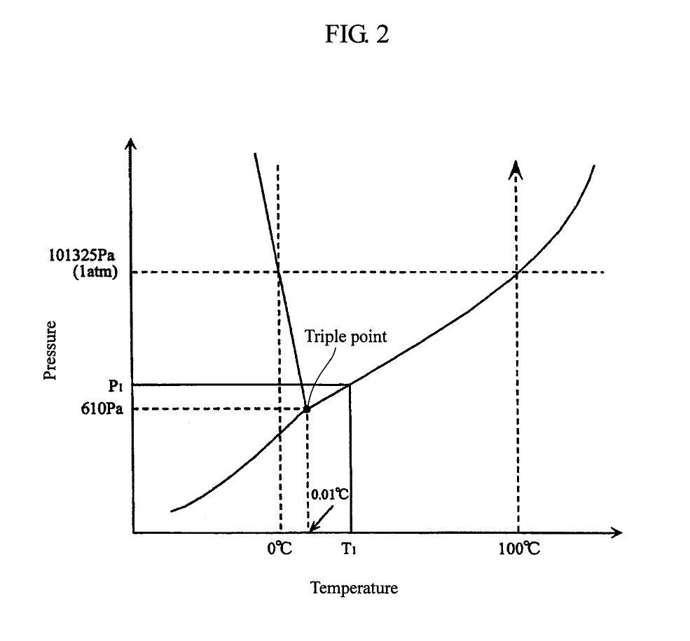

FIG. 3 is a flowchart as to the function of the control panel used for a dry-type vacuum sprinkler system of the present invention.

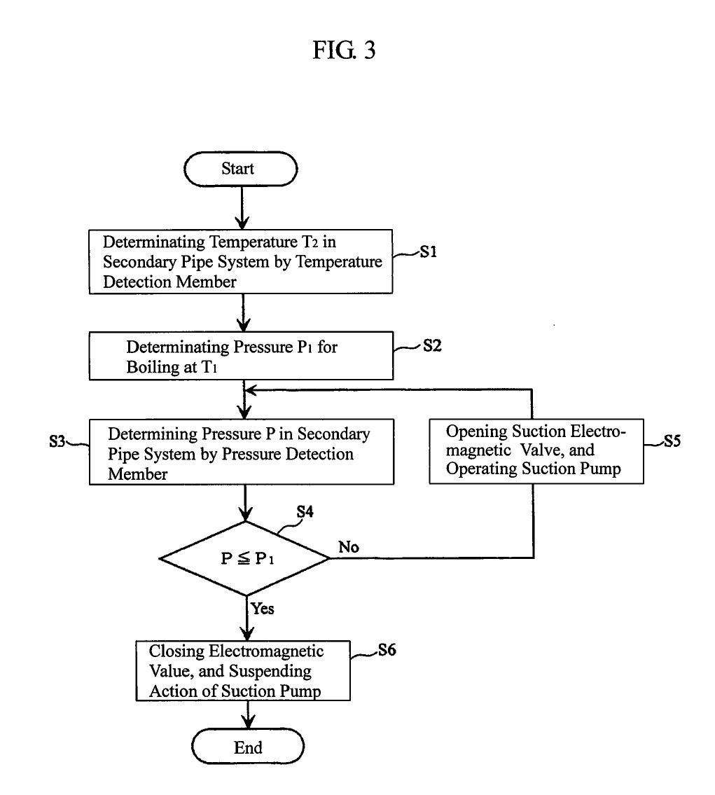

FIG. 4 is a schematic diagram for explaining an entire structure of a conventional dry-type sprinkler system.

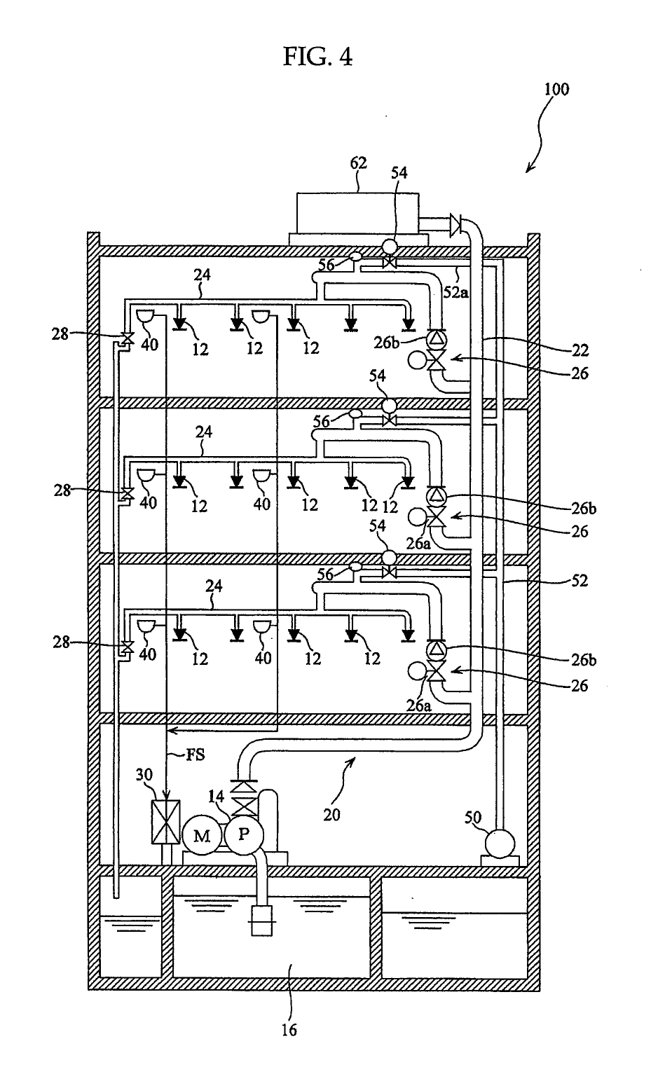

FIG. 5 is a schematic diagram for explaining an essential structure of a conventional dry-type sprinkler system.

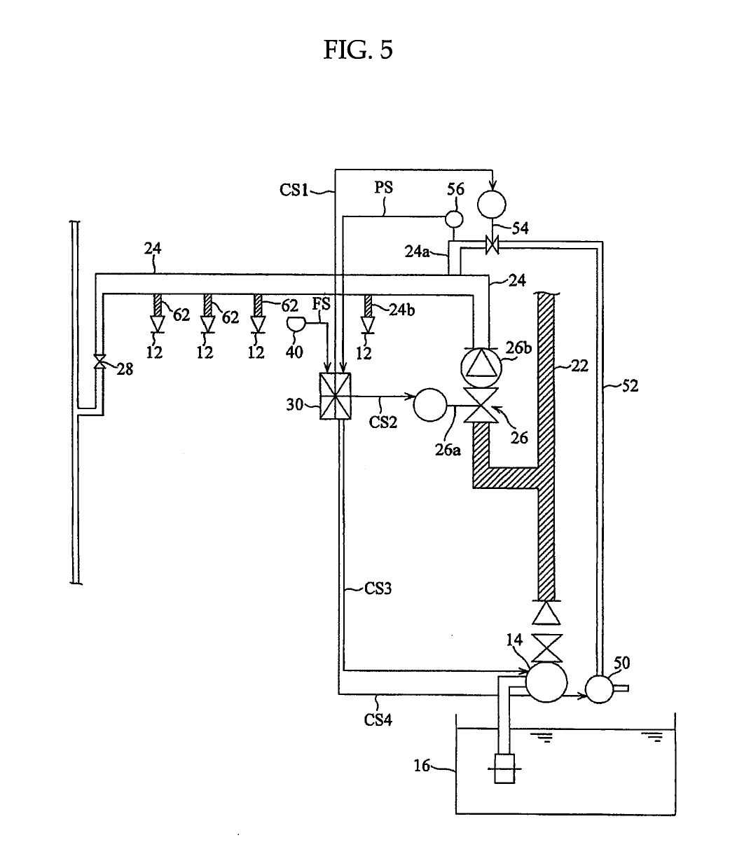

### DESCRIPTION OF REFERENCE NUMERALS

12 Sprinkler head

14 Water feed pump

22 Primary pipe system

24 Secondary pipe system

24b Hang-down pipe

30 Control panel

51 Suction pump

53 Suction pipe

55 Electromagnetic valve for suction

57a Temperature detection member

57b Pressure detection member

62 Remaining water

1. A dry-type vacuum sprinkler system comprising:
sprinkler heads which function individually,
a water supply unit provided for supplying water to the sprinkler heads,
a water feed pipe system unit configured as a water supply path for supplying water from the water supply unit to the sprinkler heads, the water supply unit comprising:
a primary pipe system connected to the water supply unit,
a secondary pipe system connected to the sprinkler heads, and
a gate valve provided between the primary pipe system and the secondary pipe system and partitioning the water feed pipe system into the primary pipe system and the secondary pipe system, the gate valve being closed in a normal condition,
a fire detection member which transmits a fire signal upon detection of a fire,
a control unit for controlling an operation of the water supply unit and an open-close action of the gate valve, and
a negative pressure state maintenance member by which the primary pipe system is filled with water, and the inside the secondary pipe system being maintained in a negative pressure condition as a normal condition, the negative pressure state maintenance member comprising a pressure control unit which maintains the inside of the secondary pipe system in a negative pressure state in the normal condition, and a temperature detection member which detects a temperature in the secondary pipe system, and a pressure detection member which detects a pressure in the secondary pipe system, the pressure control unit controlling the pressure in the secondary pipe system in the normal condition so that water remaining in the secondary pipe system boils at a temperature detected by the temperature detection member.

2. (canceled)

3. The dry-type vacuum sprinkler system as claimed in claim 1, wherein the negative pressure state maintenance member controls the pressure in the secondary pipe system to be a predetermined value when the pressure in the secondary pipe system which was determined by the pressure detection member becomes greater than the predetermined value.

4. (canceled)

5. The dry-type vacuum sprinkler system as claimed in claim 1, wherein the negative pressure state maintenance member further comprises:
a suction pipe extending to a position above the secondary pipe system and communicating with the secondary pipe system, and
a suction member for suctioning air in the secondary pipe system by way of the suction pipe to have a negative pressure in the secondary pipe system.

6. (canceled)
